(19) United States
(12) Patent Application Publication
(10) Pub. No.: US 2025/0289299 A1
(43) Pub. Date: Sep. 18, 2025

(54) SEAL ASSEMBLY OF A SLIDE-OUT FOR A RECREATIONAL VEHICLE AND SYSTEM THEREOF

(71) Applicant: Forest River, Inc., Elkhart, IN (US)

(72) Inventor: Toby J. Crowley, Syracuse, IN (US)

(21) Appl. No.: 19/079,556

(22) Filed: Mar. 14, 2025

Related U.S. Application Data
(60) Provisional application No. 63/566,425, filed on Mar. 18, 2024.

(51) Int. Cl. B60J 10/244; B60J 10/84; B60P 3/34; B60R 16/03

(52) U.S. Cl. CPC B60J 10/244; B60J 10/84; B60P 3/34; B60R 16/03

(57) ABSTRACT

A control system of a recreational vehicle includes a controller, a power source configured to provide electrical power to the controller, and an actuator operably coupled to the controller. The actuator is configured to controllably move a slide out assembly between a closed position and an open position. The control system includes a seal assembly having an inlet. A fluid pressure device is operably coupled to the controller and is fluidly coupled to the inlet of the seal assembly. The controller is configured to operably control the fluid pressure device to pressurize the seal assembly when the slide out assembly is in the closed position.

### RELATED APPLICATIONS

This application claims the benefit of U.S. Provisional Patent Application Ser. No. 63/566,425, filed Mar. 18, 2024, the disclosure of which is hereby incorporated by reference in its entirety.

### FIELD OF THE DISCLOSURE

The present disclosure relates to a recreational vehicle such as, for example, a travel trailer or fifth wheel trailer, and more particularly to a seal assembly of a slide-out for a recreational vehicle.

### BACKGROUND

Recreational vehicles provide individuals with spacious, comfortable and transportable lodging. In particular, a typical recreational vehicle comprises a housing member having a multi-level interior living space formed therein, a multi-level chassis adapted to support the housing member, and a carriage member having a plurality of wheels interposed between the chassis and a supporting surface so as to enable the trailer to travel on the supporting surface. Furthermore, the typical recreational vehicle may be detachably mounted to a towing vehicle so that a front end of the vehicle extends beyond the load bearing rear wheels of the towing vehicle so as to enable the towing vehicle to essentially act as a fifth wheel trailer. Alternatively, the recreational vehicle may be motorized such as a motorhome vehicle.

Since recreational vehicles are currently available with lengths as great as forty-five feet (and possibly longer) and pop-out sections that provide the housing member with increased width, their interior living spaces are able to resemble that of a nicely appointed home. For example, a recreational vehicle can include a large kitchen, a large bathroom, a large bedroom, and a large living area. Moreover, these vehicles typically include multiple water storage tanks for supplying hot and cold water as well as for storing wastewater, wiring for distributing electrical power and a central heating/ventilation/air conditioning (HVAC) system for providing desirable environmental conditions within the interior living space.

### SUMMARY

In one implementation of the present disclosure, a control system of a recreational vehicle having an outer wall and a slide out assembly includes a controller; a power source configured to provide electrical power to the controller; an actuator operably coupled to the controller, the actuator configured to controllably move the slide out assembly between a closed position and an open position; a seal assembly comprising an inlet; and a fluid pressure device operably coupled to the controller, the fluid pressure device being fluidly coupled to the inlet of the seal assembly; wherein, the controller is configured to operably control the fluid pressure device to pressurize the seal assembly when the slide out assembly is in the closed position.

In one example of this implementation, the actuator includes a base and a rod, the rod being movable between an extended position and a retracted position; wherein, the controller is configured to control the rod to move to the extended position when the slide out assembly is in the open position, and the controller is configured to control the rod to move to the retracted position when the slide out assembly is in the closed position. In a second example, a sensor is operably coupled to the controller, the sensor configured to detect a pressure in the seal assembly. In a third example, the controller is configured to control movement of the actuator based on the pressure in the seal assembly.

In a fourth example, the actuator is configured to move the slide out assembly based on the pressure in the seal assembly. In a fifth example, the seal assembly is coupled to the slide out assembly, the seal assembly being disposed between the slide out assembly and the outer wall in the closed position. In a sixth example, the controller is configured to operably control the fluid pressure device to increase pressure in the seal assembly based on a position of the slide out assembly relative to the open position and the closed position. In a seventh example, a valve assembly is operably coupled to the seal assembly, the valve assembly being in communication with the controller; wherein, the controller is configured to actuate the valve assembly to reduce a pressure in the seal assembly.

In an eight example, the control system includes a first sensor and a second sensor, the first sensor and second sensor being in communication with the controller, wherein the first sensor is configured to send a signal to the controller when the slide out assembly is in the closed position and the second sensor is configured to send a signal to the controller when the slide out assembly is in the open position. In a ninth example, when the controller does not receive a signal from either the first sensor or the second sensor, the controller is configured to determine the slide out assembly is at a position between the open position and the closed position. In a tenth example, a switch is disposed in electrical communication between the power source and the controller; wherein, when the switch is enabled, the switch is configured to electrically couple the power source to the controller; wherein, when the switch is disabled, the switch is configured to electrically decouple the power source from the controller. In yet another example, when the switch is enabled, the actuator is electrically coupled to the power source.

In another implementation of the present disclosure, a control system is provided of a recreational vehicle having an outer wall, a first slide out assembly, and a second slide out assembly. The control system includes a controller; a power source configured to provide electrical power to the controller; a first actuator operably coupled to the controller, the first actuator configured to controllably move the first slide out assembly between a closed position and an open position; a second actuator operably coupled to the controller, the second actuator configured to controllably move the second slide out assembly between a closed position and an open position; a first seal assembly coupled to the first slide out assembly or the outer wall, the first seal assembly being located between the first slide out assembly and the outer wall when the first slide out assembly is in the closed position; a second seal assembly coupled to the second slide out assembly or the outer wall, the second seal assembly being located between the second slide out assembly and the outer wall when the second slide out assembly is in the closed position; a fluid pressure device operably coupled to the controller, the fluid pressure device being fluidly coupled to the first seal assembly and the second seal assembly; wherein, the controller is configured to operably control the fluid pressure device to pressurize the first seal assembly and the second seal assembly.

In a first example of this implementation, the first seal assembly is pressurized when the first slide out assembly is in the closed position, and the first seal assembly is de-pressurized when the first slide out assembly is in any position other than the closed position; the second seal assembly is pressurized when the second slide out assembly is in the closed position, and the second seal assembly is de-pressurized when the second slide out assembly is in any position other than the closed position. In a second example, a manifold is fluidly coupled between the fluid pressure device and each of the first and second seal assemblies. In a third example, a valve assembly is operably controlled by the controller, the valve assembly configured to move between at least a first position and a second position; wherein, in the first position, the fluid pressure device is fluidly coupled to at least one of the first seal assembly and the second seal assembly; wherein, in the second position, the fluid pressure device is fluidly decoupled from the first and second seal assemblies.

In another example, the control system includes at least a first switch and a second switch, the first and second switches disposed in electrical communication between the power source and the controller; wherein, when the first switch is enabled, the first switch is configured to electrically couple the power source to the first actuator; wherein, when the second switch is enabled, the second switch is configured to electrically couple the power source to the second actuator. In yet another example, the control system includes a first sensor and a second sensor, the first and second sensors operably coupled to the controller; wherein, the first sensor is configured to detect a pressure in the first seal assembly; wherein, the second sensor is configured to detect a pressure in the second seal assembly.

In a further implementation of the present disclosure, a method of controlling a slide out assembly of a recreational vehicle is provided. The recreational vehicle includes an outer wall, a controller, a power source, a fluid pressure device, an actuator, and a seal assembly. The method includes receiving a signal via the controller to controllably move the slide out assembly from an open position to a closed position; sending a signal to move the actuator from an extended position to a retracted position; detecting a pressure in the seal assembly; pressurizing the seal assembly via the fluid pressure device as the slide out assembly moves from the open position to the closed position; compressing the seal assembly between the slide out assembly and the outer wall as the slide out assembly moves to the closed position; and sealing a gap between the slide out assembly and the outer wall via the seal assembly.

In one example of this implementation, the method includes adjusting, by the controller, the pressure in the seal assembly by increasing the pressure via the fluid pressure device and decreasing the pressure via a valve assembly located on the seal assembly.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side view of a travel trailer;

FIG. 2 is a partial perspective view of a slide out assembly of a travel trailer;

FIG. 3 is a cross-sectional front view of a slide out assembly of a travel trailer in an open position;

FIG. 4 is a cross-sectional front view of a slide out assembly of a travel trailer in a closed position;

FIG. 5 is a diagram of a control system for a travel trailer; and

FIG. 6 is a diagram of a control system for a travel trailer.

Corresponding reference numerals are used to indicate corresponding parts throughout the several views.

### DETAILED DESCRIPTION

The implementations of the present disclosure described below are not intended to be exhaustive or to limit the disclosure to the precise forms disclosed in the following detailed description. Rather, the implementations are chosen and described so that others skilled in the art may appreciate and understand the principles and practices of the present disclosure.

In this disclosure, one or more implementations are shown and described of a recreational vehicle. For purposes of this disclosure, a recreational vehicle may be a travel trailer, a fifth wheel travel trailer, a towable travel trailer, and/or a motorhome or other motorized recreational vehicle. In some implementations, the recreational vehicle may be towed by a tow vehicle. In other implementations, the recreational vehicle may be motorized, e.g., the recreational vehicle has an engine or power-generating device, a transmission, etc. In several implementations, the recreational vehicle may be electrically-powered such as an electric vehicle. In other implementations, the recreational vehicle may be a hybrid-powered vehicle. For purposes of this disclosure, the implementations described hereinafter will be referred to as a travel trailer, but it is to be understood the travel trailer is a recreational vehicle that may be towed or motorized.

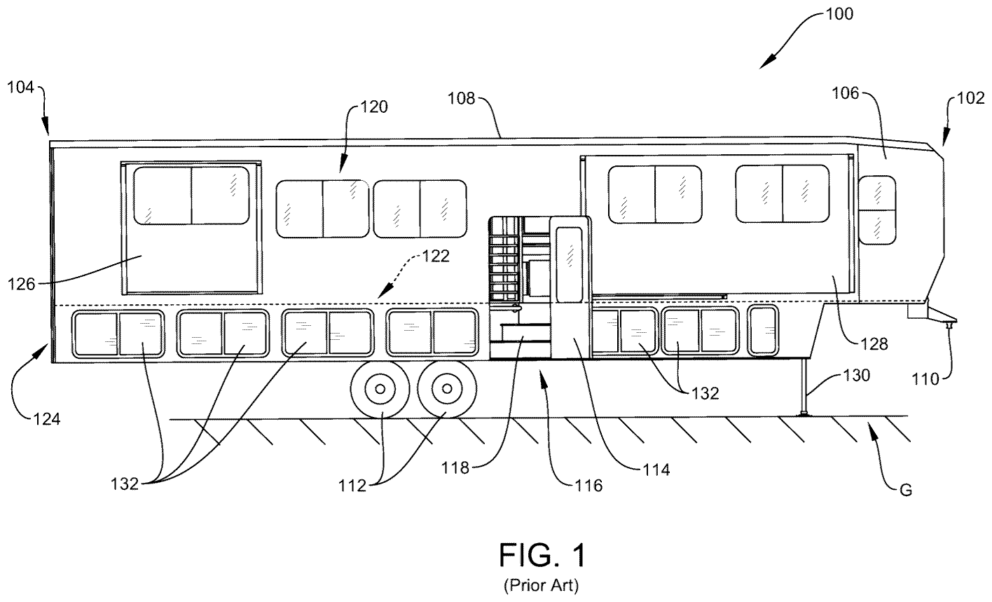

Referring to FIG. 1, an implementation of a travel trailer 100 is illustrated. This trailer 100 may include a front end 102 and a rear end 104. For instance, an interior floor 122 of the trailer 100 may lie along a substantially horizontal plane between the front 102 and rear 104 thereof. The single-level trailer 100 may be formed as a body 106 supported by a frame assembly or chassis (not shown). The frame assembly or chassis may be a drop frame assembly or a straight frame assembly. The body 106 and frame assembly may be further supported by one or more wheels 112.

The body 106 may include an overhead roof 108 as shown in FIG. 1. Further, a hitch 110 may be located at the front end 102 of the trailer for coupling to a towing vehicle (not shown). When the trailer 100 is disconnected from the towing vehicle, a support member 130 or landing gear may be provided to support the front end 102 thereof.

The body 106 may include skirting (not shown). In other implementations, the trailer may not include any skirting.

A door 114 may be coupled to the body 106 to allow access between the interior of the trailer 100 and outside thereof. The door 114, when opened, allows access to an entryway 116 which may be accessed by a set of steps 118 between the ground, G, and a living area 120 of the trailer 100. In one implementation, the entryway 116 may have a width greater than the typical 30″ found on some multi-level fifth wheel trailers. For instance, the passageway 116 may have a width between 30-40 inches. In a further example, the width may be between 32-38 inches. In yet a further example, the width may be approximately 36 inches. The present disclosure is not intended to be limited to any type of width of the entryway 116.

The trailer 100 may include a first slide out 126 and a second slide out 128. The slide outs, when configured in their deployed positions, allow the single level living area 120 to increase in living space as the side wall of the body 106 moves outwardly a predetermined distance. While the trailer 100 of FIG. 1 includes a pair of slide outs, this is not intended to be limiting. The trailer 100 may include any number of slide outs for purposes of the present disclosure.

The travel trailer may include a height defined between the floor 122 and ceiling. In some implementations, the height may be approximately the same throughout, whereas in other implementations, the height may vary between the front 102 and rear 104. In FIG. 1, a first height, H₁, at the rear 104 of the trailer 100 may be approximately, if not exactly, the same as a second height, H₂, at the front 102 thereof. For example, the heights may be up to 84 inches. Conventional multi-level fifth wheel travel trailers having varying heights throughout the interior living spaces depending upon the location therein. For instance, a conventional multi-level fifth wheel may have heights that vary between 75 inches and 105 inches, where the less headroom is normally found in those living spaces that are elevated at the front and/or rear of the trailer.

The floor level 122 may separate the living space 120 of the trailer 100 from a storage compartment or basement 124. The storage compartment 124 may be accessed by any one of a plurality of storage doors 132. The storage compartment 124 of the travel trailer 100 of FIG. 1 may be individual compartments or a full pass-through storage space that runs continuously (e.g., uninterrupted) from the rear end 104 of the trailer 100 to a location towards the front end 102 thereof. The storage compartment 124 may be formed of a single piece of composite material which can reduce the overall cost of the trailer 100. In other implementations, the storage compartment 124 may be formed of other material besides composite.

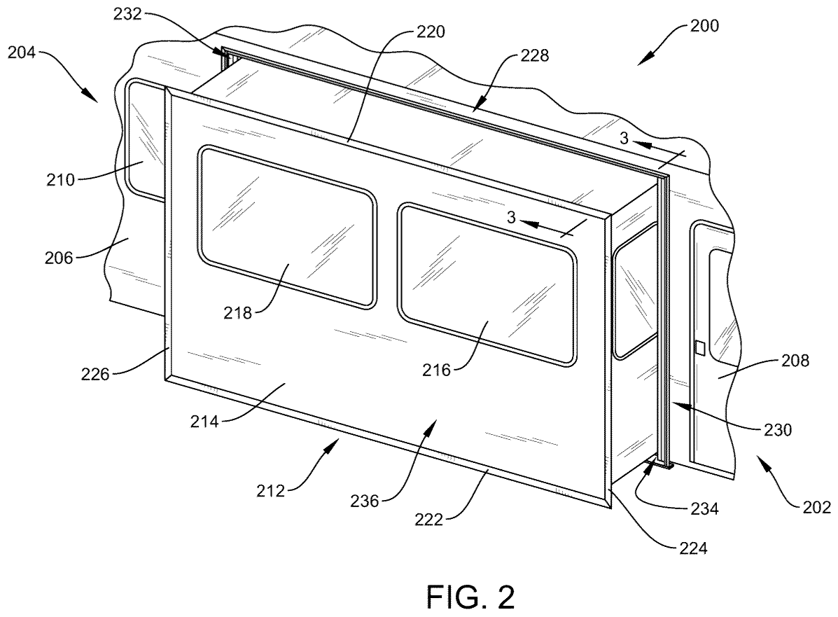

Referring to FIG. 2 of the present disclosure, one implementation of a travel trailer or other recreational vehicle (e.g., fifth wheel trailer, etc.) is disclosed. In one implementation, the travel trailer may be a powered vehicle having a power system (e.g., engine, transmission, etc.) for propelling it in a travel direction. In another implementation, the travel trailer may be towed or pulled by a powered vehicle (e.g., a truck) in a travel direction. Other implementations are contemplated and fit within the scope of the present disclosure.

The travel trailer 200 of FIG. 2 is partially shown but may include features similar to those disclosed in FIG. 1. The trailer 200 may include a front end 202, a rear end 204, and an outer wall or side wall 206. Similar to the implementation of FIG. 1, the travel trailer 200 may include an entry opening in the side wall 206 whereby a door 208 provides access to an interior of the travel trailer 200. Moreover, in at least some implementations, the travel trailer 200 may include one or more windows. In FIG. 2, for example, the trailer 200 may include a first window 210.

In some implementations, the travel trailer 200 may include one or more slide out assemblies. In other implementations, the trailer may not include any slide out assemblies. In the implementation of FIG. 2, the travel trailer 200 may include at least one slide out assembly 212. As shown, the slide out assembly 212 is shown in an open position or an at least partially open position. In this position, the slide out assembly 212 is extended or moved outwardly away from the side wall 206. As is known in the art, moving the slide out assembly 212 to the open position may create additional living space in the interior of the travel trailer 200. This is advantageous in that more space is provided so that more people can occupy the interior of the travel trailer 200.

The travel trailer 200 may include an opening formed in the side wall 206. The opening is configured to receive or at least partially receive the slide out assembly 212 when in the open, in the at least partially open position, or in a closed position.

Referring to the slide out assembly 212 of FIG. 2, the slide out assembly 212 may include an outer wall 214. The outer wall 214 may be formed of a fiberglass material. Other materials may be used for slide out assemblies and the present disclosure is not limited to a fiberglass wall of the slide out assembly. The implementations of FIGS. 1 and 2 are illustrated as a travel trailer. In other implementations, however, the principles and teachings of the present disclosure may be applicable to slide boxes in other motorized applications. Moreover, the slide out assemblies or slide boxes may not be planar in all implementations. For example, in some implementations, the contour of the slide out assemblies or slide boxes may vary vertically or horizontally. In another example, in a B van application, a slidable door assembly may be used to selectively “plug” or “seal” a slide out assembly or slider box. Other shapes and forms of opening may be used in the present disclosure.

In several implementations, the slide out assembly 212 may include one or more windows. In FIG. 2, for example, the slide out assembly 212 may include a first window 216 and a second window 218. Additional windows may be provided. In other implementations, the slide out assembly 212 may not include any windows.

In the slide out assembly 212 of FIG. 2, an outer trim piece or member may be provided for coming into contact with the side wall 206 of the travel trailer 200 in the closed position. The outer trim piece or member may be disposed about a perimeter of the slide out assembly 212. In the illustrated implementation of FIG. 2, the outer trim member may include an upper trim member 220, a lower trim member 222, a first side trim member 224, and a second side trim member 226.

The present disclosure contemplates an improvement to the slide out seal assemblies for better sealing the travel trailer and slide out assembly in the closed position and/or the open position or at least partially open position. Moreover, the present disclosure provides a better seal assembly that may inflate, expand, deflate, and/or compress to adjust the size of any gap between the slide out assembly and the travel trailer.

In FIG. 2, the travel trailer 200 may include a seal assembly. In this implementation, the seal assembly is shown having an upper seal assembly 228, a first side seal assembly 230, and a second side seal assembly 232. In other implementations, there may be a lower seal assembly. Each seal assembly may include a bladder having at least one inlet. The bladder may be filled with a fluid such as air to inflate the seal assembly. In some implementations, the bladder may be filled with water or another known liquid. In several implementations, the bladder may be filled with air or other gas. In further implementations, the bladder may be filled with a liquid-gas combination. For purposes of this disclosure, the seal assembly may be inflated with a fluid that may have any composition such as a liquid, gas, or combination thereof.

The slide out assembly 212 may be extended or retracted to move the slide out assembly 212 between the closed position and the open or at least partially open position. Specifically, the slide out assembly 212 may be extended and retracted via one or more cables (not shown) in one implementation. In another implementation, the slide out assembly 212 may be actuated between the open or at least partially open position and the closed position via one or more actuators. In one example, the one or more actuators may be a linear actuator. In another example, the one or more actuators may be a mechanical actuator. In a further example, the one or more actuators may be an electric actuator. In yet another example, the one or more actuators may be a hydraulic actuator. In yet further examples, other types of actuators may be used to move the slide out assembly 212 relative to the outer wall 206 of the trailer 200. In yet even further examples including more than one actuator, any combination of different actuators may be used. Moreover, there may be other drive system beyond cables and actuators that may move the slide out assembly 212 between its open and closed positions, and the present disclosure is not limited to any type of drive system.

In FIG. 2, the slide out system 212 may include a slide out body 236. The slide out body 236 may also include the slide out outer wall 214, which may be referred to as an outer skin in some implementation. The outer wall may be formed of fiberglass, aluminum, steel or other related material.

As also shown in FIG. 2 of the present disclosure, the outer wall 206 of the travel trailer 200 along with the seal assembly is shown. Here, the outer wall 206 may be formed by an outer layer or skin of fiberglass, aluminum, steel or other material.

The seal assembly includes a seal. In some implementations, the seal may be inflatable or expandable. The seal may be formed of a pliable material, for example, rubber or a similar material. Due to this characteristic, the seal may be expanded or inflated expanding a cross sectional area of the seal, or the seal may be deflated or compressed shrinking the cross sectional area of the seal.

In some implementations, the seal may be made of a deformable material. The deformable material may be foam. The deformable material may at least partially deform upon compression of the seal between the slide out assembly 212 and another part of the trailer 200. For example, when the slide out assembly 212 is in the closed position, the seal may be compressed between the outer trim member and the outer wall 206. The deformable material may bias back to an uncompressed or expanded state when the seal is not compressed. For example, when the slide out assembly is in the open or at least partially open position, the seal may be in its expanded or uncompressed state.

In some implementations, the seal assembly may include both an inflatable seal and an expandable seal made of a deformable material. For example, the upper seal assembly 228 may include an inflatable seal while the first side seal assembly 230 and the second side seal assembly 232 may include a foam seal. The seal assembly may include any number of seals including both inflatable seals and seals made of a deformable material. In some implementations, the seal assembly may include an inflatable seal with another seal made of a deformable material attached to the inflatable seal. For example, the seal assembly may include an inflatable seal with a foam seal at least partially surrounding the inflatable seal. Having both an inflatable seal and a foam seal at least partially surrounding the inflatable seal helps to ensure the slide out assembly 212 will be sealed with the outer wall 206 if the inflatable seal were to be damaged, such as the inflatable seal being popped and thus not able to be inflated.

The seal assembly may have a plurality of different states. For example, the seal assembly may have an inflated state, a partially inflated state, and a deflated state. The seal assembly in the inflated state may have a higher pressure inside the seal assembly than the partially inflated state and the deflated state. Similarly, the seal assembly in the deflated state may have a lower pressure inside the seal assembly than the inflated state and the partially inflated state. The seal assembly in the partially inflated state may have a pressure inside the seal assembly that is in between the inflated state and the deflated state. The seal assembly may include more states that contain different pressures than the inflated state, the partially inflated state, and the deflated state.

The seal may form part of the upper seal assembly 228, the first side seal assembly 230, and the second side seal assembly 232. In some implementations, the seal may form part of the lower seal assembly. In some implementations, the seal assembly may include more than one seal. One or more seals may be fluidly coupled to another seal. In some implementations, any of or all of the upper seal assembly 228, the first side seal assembly 230, the second side seal assembly 232, and lower seal assembly may be fluidly coupled to one another.

In some implementations, the seal assembly may be coupled to the slide out assembly 212. In some implementations, the seal assembly may be coupled to the trailer 200, for example, about a perimeter of the opening in the side wall 206.

The seal assembly may surround or at least partially surround a part of the slide out assembly 212. In one implementation, the seal assembly may be located on the top and sides of the opening in the outer wall 206 and thus adjacent to the slide out assembly 212. In another implementation, the seal assembly may be located on the top, bottom, and sides of the opening in the outer wall 206 and thus adjacent to the slide out assembly 212. In yet another implementation, the seal assembly may be located on a top surface and side surfaces of the slide out body 236 of the slide out assembly 212. In yet a further implementation, the seal assembly may be located on the top, a bottom, and side surfaces of the slide out assembly 212. In such implementations where the seal assembly is located on one or more surfaces of the slide out body 236, the seal assembly may be positioned at or near the side wall 214 such that when the slide out assembly 212 is in the closed position, the seal assembly is thus adjacent to the outer wall 206.

The seal assembly may be positioned further away from the slide out outer wall 214 such that the seal may be at or near the outer wall 206 when the slide out assembly is in the open or at least partially open position. In some implementations, more than one seal assembly may be positioned on one or more surfaces of the slide out body 236. For example, one seal assembly may be positioned such that the seal assembly is at or near the outer wall 206 such that when the slide out assembly 212 is in the closed position and another seal assembly is positioned such that at or near the outer wall 206 when the slide out assembly is in the open or at least partially open position.

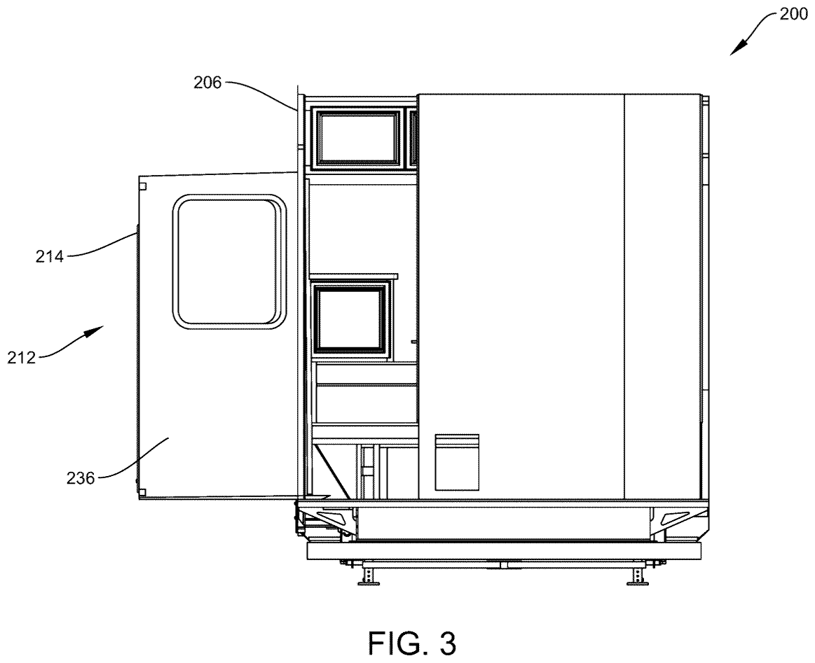

In FIG. 3, the slide out assembly 212 is located in the open or at least partially open position. In other words, the slide out assembly 212 is moved away from the outer wall 206. In some implementations when in the open or at least partially open position, the seal assembly may not be in contact with the outer trim member. In some implementations, the seal assembly may be deflated in the open or at least partially open position. In some implementations, the seal assembly may be inflated in the open or at least partially open position. In some implementations, the seal may be partially inflated in the open or at least partially open position. The seal assembly may be in an expanded state when the slide out assembly 212 is in the open or at least partially open position.

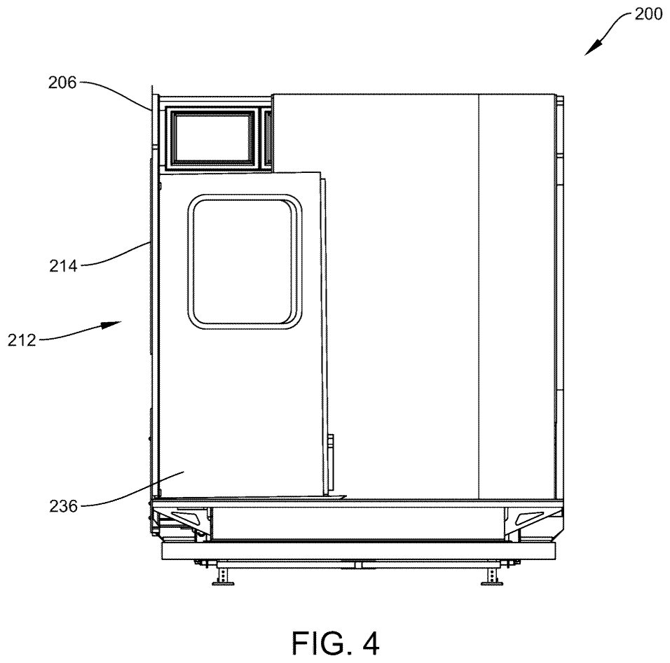

Referring to FIG. 4, the slide out assembly 212 is in its closed position. Here, the slide out assembly 212 is disposed in contact with the outer wall 206 of the travel trailer 200. The outer trim member may be located proximate to or in contact with the outer wall 206. In some implementations, the slide out assembly may at least partially compress the seal assembly. For example, the outer trim member may contact and at least partially compress the seal assembly. The seal assembly may prevent rain, dirt and other debris or contaminants from getting behind the slide out assembly 212. In this arrangement, the seal assembly may be better protected from the elements and provide a better seal to protect the interior of the travel trailer from the same debris and/or mold or other damage.

When the slide out assembly 212 is in the closed position, the seal assembly may be inflated. Inflating the seal assembly helps reduce the size of any gap in the opening of the outer wall 206 and the slide out assembly 212. When the slide out assembly 212 is in the closed position, the seal assembly may be deflated. In some implementations, the seal assembly may be partially inflated when the slide out assembly 212 is in the closed position.

As mentioned herein, the slide out assembly 212 may move from the closed position to the open or at least partially open position. The slide out assembly 212 may also move from the open or at least partially open position to the closed position. In some implementations, the seal assembly may be inflated when the slide out assembly 212 is stationary or not moving, for example, when the slide out assembly 212 is in the closed position, the open position, or the at least partially open position. The seal assembly may also be deflated when the slide out assembly 212 is stationary or not moving, for example, when the slide out assembly 212 is in the closed position, the open position, or the at least partially open position. For example, the slide out assembly 212 may initially be in the closed position with the seal assembly inflated. The seal assembly may then be deflated to the partially inflated or deflated state as the slide out assembly is moved into the open or at least partially open position. Deflating the seal assembly reduces the chances of damaging the seal assembly when the slide out assembly 212 is sliding in or out from the opening of the outer wall 206.

As the slide out assembly 212 is being moved from the closed position to the open or at least partially open position, the seal assembly may remain in the partially inflated or deflated state as to let the slide out assembly reach the open or at least partially open position without damaging the seal assembly. In some implementations, the seal assembly may be inflated as the slide out assembly 212 is moving from the closed position to the open or at least partially open position.

Similarly, as the slide out assembly 212 is being moved from the open or at least partially open position to the closed position, the seal assembly may remain in the partially inflated or deflated state as to let the slide out assembly reach the closed position without damaging the seal assembly. In some implementations, the seal assembly may be inflated as the slide out assembly 212 is moving from the open or at least partially open position to the closed position. After the slide out assembly 212 reaches the closed position, the seal assembly may be inflated.

The slide out assembly 212 may also move from the partially open position to the open position. The seal assembly may be in the inflated state, partially inflated, or deflated state before moving. The seal assembly may remain in the inflated state, partially inflated, or deflated state as the slide out assembly 212 moves from the at least partially open position to the open position. The seal assembly may then be inflated or deflated when the slide out assembly 212 reaches the open position.

The seal assembly may be inflated or deflated by a fluid pressure device, for example, an air compressor. However, the fluid pressure device may be any other fluid device that may distribute fluid (i.e., a liquid or a gas). In some implementations, there may be more than one fluid pressure device. In one implementation, a first fluid pressure device may be fluidly coupled to the seal assembly. For example, a first fluid pressure device may be fluidly coupled to one seal in the seal assembly. In another implementation, the first fluid pressure device and a second fluid pressure device may be fluidly coupled to the seal assembly. In yet another implementation, NI number of fluid pressure devices may be fluidly coupled to the seal assembly, where Ni is any number.

The fluid pressure device may be fluidly coupled to more than one seal of the seal assembly. For example, the first pressure device may be fluidly coupled to a first seal and a second seal of the seal assembly. In one implementation, the fluid pressure device may be fluidly coupled to N₂ number of seals, where N₂ is any number.

In some implementations, the fluid pressure device may be fluidly coupled to one or more seal assemblies. For example, the fluid pressure device may be fluidly coupled to the upper seal assembly 228, the first side seal assembly 230, and the second side seal assembly 232. In some implementations, the fluid pressure device may be fluidly coupled to the seal assembly of slide out assembly 212 as well as another seal assembly of a different slide out assembly. In some implementations, a fluid manifold distribution block may be used to fluidly couple the fluid pressure device to one or more seal assemblies.

In additional implementations, the outer trim member may be optional. Thus, in at least some implementations, the slide out assembly 212 may not include the outer trim piece or member disposed about its perimeter.

The travel trailer 200 may also contain a control system. The control system is configured to control the position of the slide out assembly 212. In some implementations, the control system may control the inflation or deflation of the seal assembly.

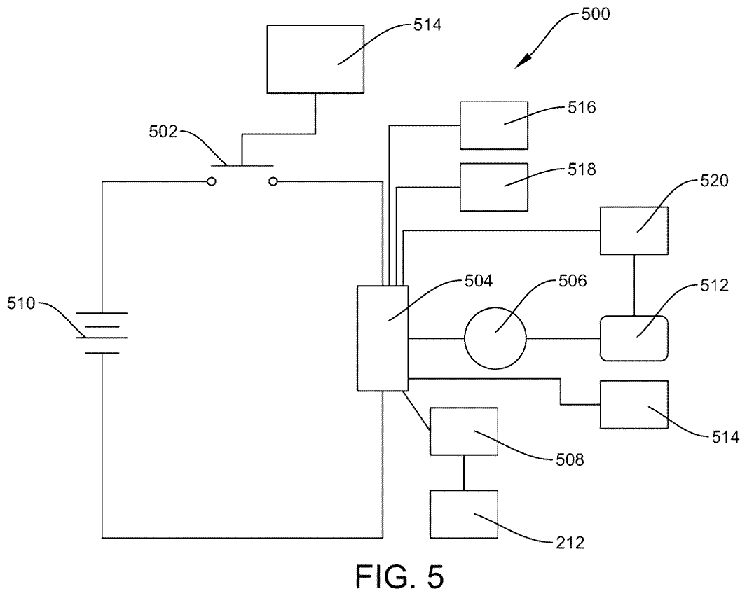

In FIG. 5, an exemplary control system 500 is shown. The control system 500 may include a switch 502 and a controller 504. The control system 500 may include a fluid pressure device 506 and an actuator 508. The actuator 508 may be an electric actuator, a hydraulic actuator, a mechanical actuator, a pneumatic actuator or a combination thereof. In some implementations, the actuator 508 may include a base and rod, where the rod moves between a retracted position and an extended position relative to the base.

In the control system 500, the fluid pressure device 506 may be fluidly coupled to a seal assembly 512. In one implementation, the fluid pressure device 506 is a compressor. The control system 500 may also contain a power source 510. In one implementation, the power source 510 may be a battery. In another implementation, the power source may be a source of electrical power from an electrical outlet or other known source. In any event, the control system 500 may control the pressure inside the seal assembly 512 via the controller 504 and a valve assembly 520. The valve assembly 520 may be a bleed valve located on the seal assembly 512. The valve assembly 520 may be operably controlled by the controller 504 to allow air or other fluid in the seal assembly 512 to be released in one state and maintain fluid pressure in the seal assembly 512 in another state.

The switch 502 of the control system 500 is configured to control the operation of the slide out assembly 212, for example, the movement of the slide out assembly 212 between the open or at least position and the closed position. The switch 502 may be actuated by an input 514 from a user. In some implementations, the switch 502 may be a momentary switch. In some implementations, a user control device may be used by the user to provide the input 514 to actuate the switch 502. The user control device may be configured to transmit wireless signals, for example, a Bluetooth signal. The user control device, for example, may be a smartphone or a wireless remote controller. In some implementations, the input 514 from the user may be from a wired controller.

The switch 502 may be located anywhere on the travel trailer 200. For example, the switch 502 may be located on the outer wall 206 where the user may provide the input 514 to actuate the switch. In some implementations, the switch 502 may be positioned elsewhere where the user may provide the input 514 to the switch 502.

The controller 504 of the control system 500 may be coupled with a fluid pressure device 506. Similarly, as described above, the fluid pressure device 506 may be fluidly coupled to a seal assembly 512. In some implementations, seal assembly 512 may be the seal assembly of the slide out assembly 212. The controller 504 may sense or be programmed to detect the state of the seal assembly 512. The controller 504 is configured to control the fluid pressure device 506. For example, the controller 504 may provide power to the fluid pressure device 506 to inflate or deflate the seal assembly 512.

The controller 504 may control how the slide out assembly 212 moves between the open or at least partially open position and the closed position. In some implementations, the controller 504 may provide power to the actuator 508 which is configured to control movement of the slide out assembly 212. The controller 504 may be controlled by the actuation of the switch 502. In some implementations, actuation of the switch 502 enables power to be transferred to the controller 504 and other components of the control system 500 such as the actuator 508, a pressure sensor 514, a valve assembly (e.g., a bleed valve) 520, a first proximity sensor or switch 516, and a second proximity sensor or switch 518.

The controller 504 may be configured to control one or both of the fluid pressure device 506 and/or the actuator 508. As mentioned previously, the controller 504 may sense or be programmed to detect the state of the seal assembly 512. Alternatively, the pressure sensor 514 may detect the state or pressure of the seal assembly 512 and communicate the same to the controller 514. For example, the controller 504 or pressure sensor 514 may detect the pressure of the seal assembly 512 directly from the seal assembly 512 or from the fluid pressure device 506. Thus, the controller 504 may determine if the seal assembly 512 is in the inflated, partially inflated, or deflated state.

In some implementations, the controller 504 may detect the pressure of the seal assembly 512 and signal and/or provide power to the fluid pressure device 506 to inflate or deflate the seal assembly 512. In some implementations, the controller 504 may detect the pressure of the seal assembly 512 and disconnect the power to the fluid pressure device 506. For purposes of this disclosure, while the controller 504 is configured to detect the pressure of the seal assembly 512, in some implementations the pressure sensor 514 detects the pressure and communicates the pressure to the controller 504.

The controller 504 may not provide power to the actuator 508 unless the controller 504 detects the seal assembly 512 is in an appropriate state, for example, an inflated or deflated state. Once the controller 504 detects the seal assembly 512 is in the appropriate state, the controller 504 may actuate the actuator 508. The controller 504 may signal and/or provide power to actuate the actuator 508 to move the slide out assembly 212 between its open or at least partially open position and the closed position. For example, the controller 504 may provide power to a motor (not shown) to actuate the actuator 508 to move the slide out assembly 212 between its open or at least partially open position and the closed position.

The controller 504 may include accommodations for the different states of the seal assembly 512 based on different application requirements. As mentioned above, the slide out assembly 212 may move between the open position and the closed position when the seal assembly 512 is in different states (i.e., inflated, partially inflated, or deflated states). For example, the controller 504 may wait to detect that the seal assembly 512 is in the inflated, partially inflated, or deflated state before providing power to actuate the actuator 508 to move the slide out assembly 212 between the open or at least partially open position. In another example, the controller 504 may operably control the actuator 508 to move the slide out assembly 212 between the open position and the closed position and then provide power to the fluid pressure device 506 to inflate or deflate the seal assembly 512.

The power source 510 may provide power to the controller 504 and the fluid pressure device 506. The power source 510 may also provide power to actuate the actuator 508, for example, the power source 510 may provide power to a motor (not shown) to actuate the actuator 508.

As also shown in FIG. 5, some implementations of the control system 500 may include a plurality of sensors. In FIG. 5, the pressure sensor 514 may be in communication with the seal assembly 512. The pressure sensor 514 may be configured to detect a fluid pressure in the seal assembly 512 and communicate the fluid pressure to the controller 504. Based on the fluid pressure, the controller 504 may be configured to enable the fluid pressure device 506 to increase the fluid pressure or controllably open the valve assembly 520 to release pressure.

The control system 500 may also include a first sensor 516 and a second sensor 518. The first and second sensors may be proximity sensors in one implementation. The first sensor 516 is configured to detect when the slide out assembly 212 is in a first position such as a closed position. The second sensor 518 is configured to detect when the slide out assembly 212 is in a second position such as a fully open position. The first and second sensor may detect a position of the actuator between its extended and retracted positions. The first and second sensors are configured to provide a signal to the controller 504 indicative of the position or location of the slide out assembly 212 with respect to its fully closed position (first state) and fully open position (second state). In this sense, the controller 504 may be able to determine the position of the slide out assembly and when to inflate or deflate the seal assembly 512 based on the position of the slide out assembly 212 between the first and second states.

In other implementations, the controller 504 may receive a signal from the actuator 508 such as motor current to detect the position of the slide out assembly. In several implementations, sensors may be provided for detecting a position of the rod of the actuator relative to the base. Again, the position of the rod relative to the base may be communicated to the controller 504 for determining the position of the slide out assembly. In yet other implementations, a hydraulic pressure of the actuator 508 may be detected by and/or communicated to the controller 504 which is configured to determine the position of the slide out assembly 212 based on the hydraulic pressure.

In some implementations, the fluid in the seal assembly 512 is air. In some instances, the effect of natural humidity in the air can induce moisture in the seal assembly 512. Without a means for releasing the humidity and thus moisture from the seal assembly 512, the seal assembly 512 may fill with moisture that collects at the bottom of the seal assembly 512 and can impact the performance thereof. Thus, the valve assembly 520 may be a bleed valve located on the seal assembly 512 at a location where the moisture collects. The valve assembly 520 may be opened to release or allow moisture to exhaust from the seal assembly 512.

In some implementations, the controller 504 may execute control logic such that when the seal assembly 512 is inflated to a fully inflated state, the valve assembly 520 is opened such that the fluid pressure in the seal assembly 512 induces moisture to exhaust through the valve assembly 520. Further, when the seal assembly 512 is deflated to a fully deflated state, the valve assembly 502 is opened to allow moisture to exhaust therefrom. In other implementations, during an inflating process, the controller 504 may operably control the valve assembly 520 to an open position to allow the fluid pressure building in the seal assembly 512 to purge or exhaust the moisture from the seal assembly 512. The controller 504 may operably close the valve assembly after a predefined period of time or when the pressure sensor 514 detects the seal assembly 512 is fully inflated.

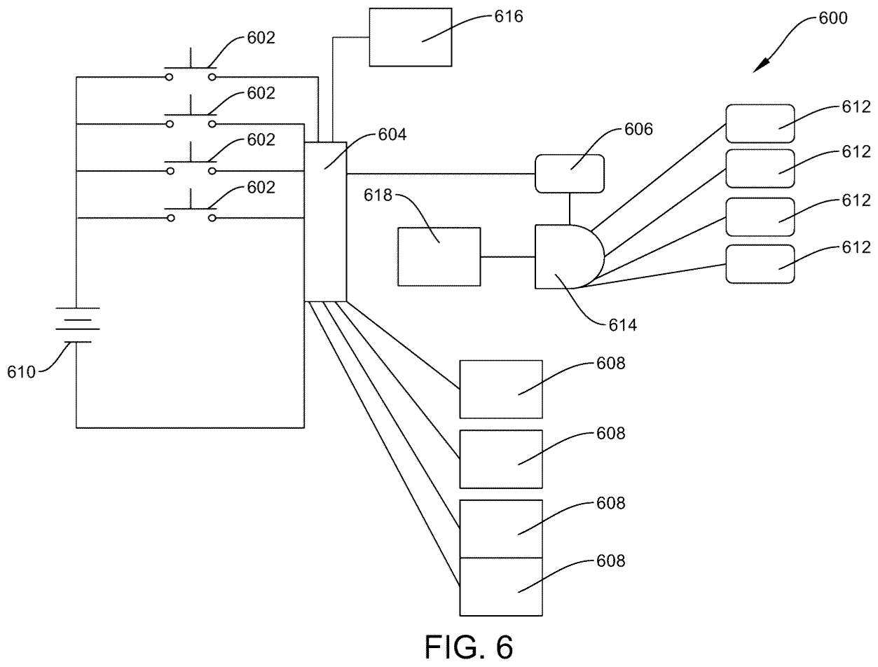

In FIG. 6, an exemplary control system 600 is shown. The control system 600 may include a user interface 616, one more switches 602 and a controller 604. The control system 600 may include a fluid pressure device 606 fluidly coupled to a fluid manifold distribution block 614. The fluid pressure device 606 and the fluid manifold distribution block 614 may be fluidly coupled to one or more seal assemblies 612. The control system 600 may be able to actuate one or more actuators 608 coupled to one or more slide out assemblies. The control system 600 may also contain a power source 610. The control system 600 may control the pressure inside the one or more seal assemblies 612.

The user interface 616 may be a switch or other user control configured to communicate with the controller 604, one of the plurality of switches, one of the actuators 608, or the fluid pressure device 606. In some implementations, the user interface 616 is on a mobile device such as a mobile phone, a laptop, a remote computing device, etc. In other implementations, the user interface 616 may be in a cab of a motorized vehicle. In several implementations, the user interface 616 may be located inside a travel trailer or other recreational vehicle.

The one or more switches 602 of the control system 600 are configured to control the operation of the slide out assembly 212, for example, the movement of the slide out assembly 212 between the open or at least position and the closed position. One or more switches 602 may be actuated by an input from a user. In some implementations, the one or more switches 602 may be momentary switches. In some implementations, a user control device may be used by the user to provide the input to actuate the one or more switches 602. The user control device may be configured to transmit wireless signals, for example, a Bluetooth signal. The user control device, for example, may be a smartphone or a wireless remote controller. In some implementations, the input from the user may be from a wired controller.

The illustrated control 600 has four switches 602. In some implementations, the input may actuate the one or more switches 602. For example, the input may actuate all four of the switches 602. In another example, the input may actuate two or three switches 602. In some implementations, more than one input may actuate the one or more switches 602. For example, in the illustrated implementation of FIG. 6, the input may control only one of the switches 602 while another input may control one or more of the other switches 602. In another example of the illustrated implementation, the input may control two or three switches 602 while another input may control the other switches 602.

The one or more switches 602 may be located anywhere on the travel trailer 200. For example, the one or more switches 602 may be located on the outer wall 206 where the user may provide the input to actuate the one or more switches 602. In some implementations, the one or more switches 602 may be positioned elsewhere where the user may provide an input to the one or more switches 602. In some implementations, one switch 602 may be located separately from one or more of the other switches 602.

The controller 604 of the control system 600 may be coupled with a fluid pressure device 606. As mentioned above, one or more seal assemblies 612 may be fluidly coupled to the fluid pressure device 606. In the illustrated implementation of FIG. 6, four seal assemblies 612 are fluidly coupled to the fluid pressure device 606. In some implementations, one or more of the seal assemblies 612 may be the seal assembly of the slide out assembly 212. The controller 604 may sense or be programmed to detect the states of the one or more seal assemblies 612. The controller 604 is configured to control the fluid pressure device 606. For example, the controller 604 may provide power to the fluid pressure device 606 to inflate or deflate the one or more seal assemblies 612.

The controller 604 may control how the slide out assembly 212 moves between the open or at least partially open position and the closed position. In some implementations, the controller 604 may provide power to actuate one or more actuators 608. The controller 604 may be controlled by the actuation of the one or more switches 602.

The controller 604 may be configured to control one or more of the fluid pressure device 606, the fluid manifold distribution block 614, and the one or more actuators 608. As mentioned previously, the controller 604 may sense or be programmed to detect the states of the one or more seal assemblies 612. For example, the controller 604 may detect the pressure of one of the seal assemblies 612 from the fluid pressure device 606. Thus, the controller 604 may determine if the one or more seal assemblies 612 are in the inflated, partially inflated, or deflated state. In some implementations, one or more of the seal assemblies 612 may be in one state, for example, the inflated state, while other seal assemblies 612 may be in one or more other states, for example, the partially inflated or deflated state.

In some implementations, the controller 604 may detect the pressure of the one or more seal assemblies 612 and signal and/or provide power to the fluid pressure device 606 to inflate or deflate one or more of the seal assemblies 612. In some implementations, the controller 604 may detect the pressure of one or more of the seal assemblies 612 and decouple or disconnect the power to the fluid pressure device 606.

In an alternative implementation, a sensor such as the pressure sensor 514 of FIG. 5 may be in communication with the controller 604 and configured to detect the pressure of one or more of the seal assemblies 612. In some implementations, there may be a pressure sensor for each seal assembly. Moreover, other features of the implementation of FIG. 5 including the valve assembly 520, first sensor 516 and second sensor 518 may be provided in the control system 600 of FIG. 6. For example, there may be a valve assembly 520 for each seal assembly 612. Moreover, there may be first and second sensors (e.g., proximity sensors) capable of detecting a position of each actuator 608 and communicating the position to the controller 604.

The fluid manifold distribution block 614 may be fluidly coupled to the fluid pressure device 606. The fluid manifold distribution block 614 may be fluidly coupled to the one or more seal assemblies 612. The fluid manifold distribution block 614 may be configured to allow the passage of fluid between the fluid pressure device 606 and one or more of the seal assemblies 612. In some implementations, the fluid manifold distribution block 614 may allow passage of fluid to only one seal assembly 612 while not allowing the fluid to pass to the other seal assemblies 612. In some implementations, the fluid manifold distribution block 614 may or may not allow the passage of fluid to all the seal assemblies 612. In some implementations, the fluid manifold distribution block 614 may allow the passage of fluid to one or more of the seal assemblies 612 while not allowing the passage of fluid to the remaining seal assemblies 612. For example, in the illustrated implementation in FIG. 6, the fluid manifold distribution block 614 may allow the passage of fluid between the fluid pressure device 606 and two of the seal assemblies 612 while not allowing the passage of fluid between the other two seal assemblies 612.

The fluid manifold distribution block 614 may be configured to allow the passage of fluid to either inflate or deflate the one or more seal assemblies 612. The fluid manifold distribution block 614 may include a solenoid valve assembly 618. The solenoid valve assembly 618 may include a solenoid and a valve. The valve may have a first position in which the passage of fluid through the valve is allowed. The valve may have a second position in which the passage of fluid through the valve is not allowed. The solenoid may be actuated by the controller 604. The actuation of the solenoid may move the valve between the first position and the second position. In some implementations, one or more solenoids may be included. In some implementations, one or more valves may be included. In some implementations, the number of solenoids and valves may be determined by the number of seal assemblies 612. In some implementations, the control system 600 may include more than one fluid manifold distribution block 614.

The controller 604 may not provide power to actuate the one or more actuators 608 unless the controller 604 detects the one or more seal assemblies 612 are in an appropriate state, for example, an inflated, partially inflated, or deflated state. Once the controller 604 detects the one or more seal assemblies 612 are in the appropriate state, it may provide power to actuate the one or more actuators 608. In some implementations, power may be provided to actuate one or more of the actuators 608 and not to the other actuators 608. For example, in the illustrated implementation of FIG. 6, four actuators 608 are shown. One of the actuators 608 may be actuated after the controller detects one or more of the seal assemblies 612 is in the appropriate state while not actuating the other remaining actuators 608. The controller 604 may signal and/or provide power to actuate the one or more actuators 608 to move the slide out assembly 212 or another slide out assembly between the open or at least partially open position and the closed position. For example, the controller 604 may provide power to a motor to actuate the one or more actuators 608 to move the slide out assembly 212 between the open or at least partially open position and the closed position.

The controller 604 may include accommodations for the different states of the one or more seal assemblies 612 based on different application requirements. As mentioned above, the slide out assembly 212 may move between the open or at least partially open position and the closed position when the one or more seal assemblies 612 are in different states (i.e., inflated, partially inflated, or deflated states). For example, the controller 604 may wait to detect that one of the seal assemblies 612 is in the inflated, partially inflated, or deflated state before providing power to actuate one of the actuators 608 to move the slide out assembly 212 between the open or at least partially open position. In another example, the controller 604 may actuate one of the actuators 608 moving the slide out assembly 212 to one of the open or at least partially open position or the closed position, provide power to the fluid pressure device 606, and control the fluid manifold distribution block 614 to inflate or deflate the one or more seal assemblies 612.

The power source 610 may provide power to the controller 604, the fluid pressure device 606, and the fluid manifold distribution block 614. The power source 610 may also provide power to actuate the one or more actuators 608, for example, the power source 610 may provide power to a motor to actuate one or more of the actuators 608.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Paseal, Curl, OCaml, JavaScript®, HTML5 (Hypertext Markup Language 5th revision), Ada, ASP (Active Server Pages), PHP (PHP: Hypertext Preprocessor), Seala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 122(f) unless an element is expressly recited using the phrase “means for,” or in the case of a method claim using the phrases “operation for” or “step for.”

While exemplary implementations incorporating the principles of the present disclosure have been disclosed hereinabove, the present disclosure is not limited to the disclosed implementations. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A control system of a recreational vehicle having an outer wall and a slide out assembly, comprising:
a controller;
a power source configured to provide electrical power to the controller;
an actuator operably coupled to the controller, the actuator configured to controllably move the slide out assembly between a closed position and an open position;
a seal assembly comprising an inlet; and
a fluid pressure device operably coupled to the controller, the fluid pressure device being fluidly coupled to the inlet of the seal assembly;
wherein, the controller is configured to operably control the fluid pressure device to pressurize the seal assembly when the slide out assembly is in the closed position.

2. The control system of claim 1, wherein the actuator comprises a base and a rod, the rod being movable between an extended position and a retracted position;
wherein, the controller is configured to control the rod to move to the extended position when the slide out assembly is in the open position, and the controller is configured to control the rod to move to the retracted position when the slide out assembly is in the closed position.

3. The control system of claim 1, further comprising a sensor operably coupled to the controller, the sensor configured to detect a pressure in the seal assembly.

4. The control system of claim 3, wherein the controller is configured to control movement of the actuator based on the pressure in the seal assembly.

5. The control system of claim 3, wherein the actuator is configured to move the slide out assembly based on the pressure in the seal assembly.

6. The control system of claim 1, wherein the seal assembly is coupled to the slide out assembly, the seal assembly being disposed between the slide out assembly and the outer wall in the closed position.

7. The control system of claim 1, wherein the controller is configured to operably control the fluid pressure device to increase pressure in the seal assembly based on a position of the slide out assembly relative to the open position and the closed position.

8. The control system of claim 1, further comprising a valve assembly operably coupled to the seal assembly, the valve assembly being in communication with the controller;
wherein, the controller is configured to actuate the valve assembly to reduce a pressure in the seal assembly.

9. The control system of claim 1, further comprising a first sensor and a second sensor, the first sensor and second sensor being in communication with the controller, wherein the first sensor is configured to send a signal to the controller when the slide out assembly is in the closed position and the second sensor is configured to send a signal to the controller when the slide out assembly is in the open position.

10. The control system of claim 9, wherein when the controller does not receive a signal from either the first sensor or the second sensor, the controller is configured to determine the slide out assembly is at a position between the open position and the closed position.

11. The control system of claim 1, further comprising a switch disposed in electrical communication between the power source and the controller;
wherein, when the switch is enabled, the switch is configured to electrically couple the power source to the controller;
wherein, when the switch is disabled, the switch is configured to electrically decouple the power source from the controller.

12. The control system of claim 11, wherein when the switch is enabled, the actuator is electrically coupled to the power source.

13. A control system of a recreational vehicle having an outer wall, a first slide out assembly, and a second slide out assembly, the control system comprising:
a controller;
a power source configured to provide electrical power to the controller;
a first actuator operably coupled to the controller, the first actuator configured to controllably move the first slide out assembly between a closed position and an open position;
a second actuator operably coupled to the controller, the second actuator configured to controllably move the second slide out assembly between a closed position and an open position;
a first seal assembly coupled to the first slide out assembly or the outer wall, the first seal assembly being located between the first slide out assembly and the outer wall when the first slide out assembly is in the closed position;
a second seal assembly coupled to the second slide out assembly or the outer wall, the second seal assembly being located between the second slide out assembly and the outer wall when the second slide out assembly is in the closed position;
a fluid pressure device operably coupled to the controller, the fluid pressure device being fluidly coupled to the first seal assembly and the second seal assembly;
wherein, the controller is configured to operably control the fluid pressure device to pressurize the first seal assembly and the second seal assembly.

14. The control system of claim 13, wherein:
the first seal assembly is pressurized when the first slide out assembly is in the closed position, and the first seal assembly is de-pressurized when the first slide out assembly is in any position other than the closed position;
the second seal assembly is pressurized when the second slide out assembly is in the closed position, and the second seal assembly is de-pressurized when the second slide out assembly is in any position other than the closed position.

15. The control system of claim 13, further comprising a manifold fluidly coupled between the fluid pressure device and each of the first and second seal assemblies.

16. The control system of claim 15, further comprising a valve assembly operably controlled by the controller, the valve assembly configured to move between at least a first position and a second position;
wherein, in the first position, the fluid pressure device is fluidly coupled to at least one of the first seal assembly and the second seal assembly;
wherein, in the second position, the fluid pressure device is fluidly decoupled from the first and second seal assemblies.

17. The control system of claim 13, further comprising at least a first switch and a second switch, the first and second switches disposed in electrical communication between the power source and the controller;
wherein, when the first switch is enabled, the first switch is configured to electrically couple the power source to the first actuator;
wherein, when the second switch is enabled, the second switch is configured to electrically couple the power source to the second actuator.

18. The control system of claim 13, further comprising a first sensor and a second sensor, the first and second sensors operably coupled to the controller;
wherein, the first sensor is configured to detect a pressure in the first seal assembly;
wherein, the second sensor is configured to detect a pressure in the second seal assembly.

19. A method of controlling a slide out assembly of a recreational vehicle, the recreational vehicle including an outer wall, a controller, a power source, a fluid pressure device, an actuator, and a seal assembly, the method comprising:
receiving a signal via the controller to controllably move the slide out assembly from an open position to a closed position;
sending a signal to move the actuator from an extended position to a retracted position;
detecting a pressure in the seal assembly;
pressurizing the seal assembly via the fluid pressure device as the slide out assembly moves from the open position to the closed position;
compressing the seal assembly between the slide out assembly and the outer wall as the slide out assembly moves to the closed position; and
sealing a gap between the slide out assembly and the outer wall via the seal assembly.

20. The method of claim 19, further comprising adjusting, by the controller, the pressure in the seal assembly by increasing the pressure via the fluid pressure device and decreasing the pressure via a valve assembly located on the seal assembly.
